(19) United States
(12) Patent Application Publication
(10) Pub. No.: US 2025/0314890 A1
(43) Pub. Date: Oct. 9, 2025

(54) IMAGE DISPLAY DEVICE AND DISPLAY DEVICE

(71) Applicant: SONY SEMICONDUCTOR SOLUTIONS CORPORATION, Kanagawa (JP)

(72) Inventor: Yoshihito FUKUSHIMA, Kanagawa (JP)

(73) Assignee: SONY SEMICONDUCTOR SOLUTIONS CORPORATION, Kanagawa (JP)

(21) Appl. No.: 18/865,803

(22) PCT Filed: Apr. 10, 2023
(86) PCT No.: PCT/JP2023/014559

§ 371 Date: Nov. 14, 2024

(30) Foreign Application Priority Data
May 30, 2022 (JP) 2022-087375

(51) Int. Cl. G02B 27/01; G02B 5/32; G02B 27/42; G03H 1/02

(52) U.S. Cl. CPC G02B 27/0172; G02B 5/32; G02B 27/4205; G02B 27/4277; G03H 1/0248; G02B 2027/0112; G02B 2027/0174

(57) ABSTRACT

An image display device in which dark lines and discoloration do not occur in the central portion of the field of view in the image projected on the retina. The present technology provides an image display device. The image display device includes a first reflection type volume hologram and a second reflection type volume hologram forming a transmission type diffraction element as a whole. The first reflection type volume hologram and the second reflection type volume hologram satisfy the Bragg condition for incident light of three colors of red, green, and blue. The first reflection type volume hologram diffracts incident light incident at an incident angle θi at a connection angle θc and deflects the incident light to the second reflection type volume hologram. The second reflection type volume hologram condenses the deflected incident light. The incident angle θi and the connection angle θc satisfy a specific condition.

### TECHNICAL FIELD

The present technology relates to an image display device and a display device. More specifically, the present technology relates to an image display device and a display device including the image display device and an image formation device.

### BACKGROUND ART

In a retinal projection device that guides the projection light flux to a retina, in order to guide the light flux emitted from the front projection light source onto the retina, the entire retinal projection device needs to be a transmission type. However, when this function is to be realized by one transmission type holographic optical element (HOE), the spectrum of the diffracted light from each hologram of three colors (hereinafter, also referred to as “R/G/B”) of red (R), green (G), and blue (B) cannot be completely separated due to its low wavelength selectivity. Therefore, a pseudo transmission type HOE is realized by combining two reflection type HOEs having different functions as illustrated in FIG. 1. FIG. 1 is a schematic diagram illustrating the transmission type HOE. In FIG. 1, θi is an incident angle, and θc is a connection angle. The two reflection type HOEs with different functions above are specifically a deflective HOE 101 and a condensing HOE 102 as shown in FIG. 1. The deflective HOE 101 is arranged on the retina side, and the condensing HOE 102 is arranged on the projection light source side so as to form the transmission type HOE.

The deflective HOE 101 has a role of deflecting the incident light incident at a certain incident angle to the condensing HOE 102 at a certain diffraction angle (connection angle). The condensing HOE 102 has a role of diffracting and reflecting the deflected light toward a certain point. A combination of these HOEs forms a transmission type HOE as a whole.

In the transmission type HOE, when the incident light is transmitted through the condensing HOE 102, the incident light passes as it is without satisfying the diffraction condition and reaches the deflective HOE 101, and the light diffracted by the condensing HOE 102 passes as it is without satisfying the diffraction condition when passing through the deflective HOE 101.

By utilizing the wavelength selectivity of the reflection type HOE, the spectra can be completely separated and the respective projected light fluxes of the R/G/B light can be selectively diffracted in the respective holograms of R/G/B. A technique using this configuration is disclosed in, for example, Patent Documents 1 to 3 below.

### CITATION LIST

### Patent Document

Patent Document 1: Japanese Patent Application Laid-Open No. 2000-28925
Patent Document 2: Japanese Patent Application Laid-Open No. 2003-161820
Patent Document 3: Japanese Translation of PCT International Application Publication No. 2017-524962

### SUMMARY OF THE INVENTION

### Problems to be Solved by the Invention

The present inventor has found that in the case of the configuration of the reflection type volume hologram as described above, a phenomenon in which a dark line or discoloration partially occurs in an image projected on the retina occurs depending on conditions.

Therefore, an object of the present technology is to provide an image display device in which dark lines and discoloration do not occur in the central portion of the field of view in the image projected on the retina.

### Solutions to Problems

The present technology provides an image display device including:
a first reflection type volume hologram and a second reflection type volume hologram forming a transmission type diffraction element as a whole, in which
the first reflection type volume hologram and the second reflection type volume hologram satisfy a Bragg condition for incident light of three colors of red, green, and blue, the first reflection type volume hologram diffracts the incident light incident at an
incident angle θi at a connection angle θc and deflects the incident light to the second reflection type volume hologram,
the second reflection type volume hologram condenses the deflected incident light, and
the incident angle θi and the connection angle θc satisfy following condition 1 or condition 2:

$$10 degrees \leq incident angle θ i \leq 90 degrees , \\ 10 degrees \leq connection angle θ c \leq 90 degrees , and \\ 4 \times incident angle θ i + connection angle θ c \leq 170 degrees , \\ and \qquad ( condition 1 )$$

$$70 degrees \leq incident angle θ i \leq 90 degrees , \\ and 70 degrees \leq connection angle θ c \leq 90 degrees . \qquad ( condition 2 )$$

$$In the image display device , \\ the incident angle θ i and the connection angle \\ θ c may satisfy following condition 1 a or condition 2 :$$

$$10 degrees \leq incidient angle θ i \leq 90 degrees , \\ 30 degrees \leq connection angle θ c \leq 90 degrees , and \\ 6 \times incident angle θ i + connection angle θ c \leq 210 degrees , \\ and \qquad ( condition 1 a )$$

$$70 degrees \leq incident angle θ i \leq 90 degrees , \\ and 70 degrees \leq connection angle θ c \leq 90 degrees . \qquad ( condition 2 )$$

A light flux incident surface of the first reflection type volume hologram and a light flux incident surface of the second reflection type volume hologram may face each other substantially in parallel.

A diffraction angle of a central portion of the second reflection type volume hologram may be approximately 0 degrees.

The incident light incident on the first reflection type volume hologram may be p-polarized light.

The incident light may be emitted from an image formation device separated from the image display device.

Moreover, the present technology further provides a display device including:
an image display device that includes a first reflection type volume hologram and a second reflection type volume hologram forming a transmission type diffraction element as a whole, in which
the first reflection type volume hologram and the second reflection type volume hologram satisfy a Bragg condition for incident light of three colors of red, green, and blue,
the first reflection type volume hologram diffracts the incident light incident at an incident angle θi at a connection angle θc and deflects the incident light to the second reflection type volume hologram,
the second reflection type volume hologram condenses the deflected incident light, and
the incident angle θi and the connection angle θc satisfy following condition 1 or condition 2; and
an image formation device that emits the incident light:

$$10 degrees \leq incident angle θ i \leq 90 degrees , \\ 10 degrees \leq connection angle θ c \leq 90 degrees , and \\ 4 \times incident angle θ i + connection angle θ c \leq 170 degrees , \\ and \qquad ( condition 1 )$$

$$70 degrees \leq incident angle θ i \leq 90 degrees , \\ and 70 degrees \leq connection angle θ c \leq 90 degrees . \qquad ( condition 2 )$$

### BRIEF DESCRIPTION OF DRAWINGS

FIG. 1 is a schematic diagram illustrating a pseudo transmission type HOE in which two reflection type HOEs having different functions are combined.

FIG. 2 is a diagram illustrating an example of partial discoloration.

FIG. 3 is a diagram illustrating an example of partial discoloration.

FIG. 4 is a diagram illustrating an example of a partial dark line.

FIG. 5 is a diagram for explaining that a part of incident light is diffracted by a condensing HOE.

FIG. 6 is a diagram for explaining that a part of diffracted light from the condensing HOE is diffracted by the deflective HOE.

FIG. 7 is a diagram for explaining calculation of a diffraction grating in a condensing HOE.

FIG. 8 is a diagram for explaining calculation of a diffraction condition of incident light incident on the condensing HOE at an incident angle θi.

FIG. 9 is a diagram illustrating calculation results of a viewing direction and a diffraction wavelength.

FIG. 10 is a diagram illustrating an example of a relationship between an incident angle and a connection angle, and a viewing direction in which unnecessary diffraction occurs.

FIG. 11 is a diagram illustrating an example of a relationship between an incident angle and a connection angle, and a viewing direction in which unnecessary diffraction occurs.

FIG. 12 is a diagram for explaining calculation of the diffraction grating in the deflective HOE.

FIG. 13 is a diagram for explaining calculation of a diffraction condition of incident light incident on the deflective HOE at an incident angle v.

FIG. 14 is a diagram illustrating calculation results of a viewing direction and a diffraction wavelength.

FIG. 15 is a diagram illustrating an example of a relationship between an incident angle and a connection angle, and a viewing direction in which unnecessary diffraction occurs.

FIG. 16 is a diagram illustrating an example of a relationship between an incident angle and a connection angle, and a viewing direction in which unnecessary diffraction occurs.

FIG. 17 is a diagram illustrating an example of a relationship between an incident angle and a connection angle, and a viewing direction in which unnecessary diffraction occurs.

FIG. 18 is a schematic view illustrating an optical system during the exposure of the condensing HOE.

FIG. 19 is a schematic diagram illustrating an optical system during the reproduction of the condensing HOE.

FIG. 20 is a diagram illustrating an example of a relationship between an incident angle and a connection angle, and a viewing direction in which unnecessary diffraction occurs.

FIG. 21 is a diagram illustrating an example of a relationship between an incident angle and a connection angle, and a viewing direction in which unnecessary diffraction occurs.

FIG. 22 is a diagram illustrating an example of a relationship between an incident angle and a connection angle, and a viewing direction in which unnecessary diffraction occurs.

FIG. 23 is a diagram illustrating an example of a relationship between an incident angle and a connection angle, and a viewing direction in which unnecessary diffraction occurs.

FIG. 24 is a diagram for explaining polarization dependency of a transmission spectrum of incident light in a central portion of the condensing HOE.

FIG. 25 is a schematic diagram illustrating an example of a display device.

FIG. 26 is a diagram illustrating an example of a state in which a user uses a display device including an image formation device.

FIG. 27 is a diagram illustrating an example of a display device including an image formation device.

### MODE FOR CARRYING OUT THE INVENTION

Preferred embodiments for implementing the present technology will be described below with reference to the drawings. The embodiments described below illustrate representative embodiments of the present technology, and the scope of the present technology is not limited only to these embodiments. The present technology will be described in the following order.
1. First Embodiment (Image Display Device)
1-1. Outline of First Embodiment
1-2. Phenomenon of Occurrence of Dark Line and Discoloration
1-3. Condition for Preventing above Phenomenon from occurring in Central Portion of Field of View
1-3-1. First Example
1-3-2. Second Example
1-3-3. Third Example
2. Second Embodiment (Display Device)

### 1. First Embodiment (Image Display Device)

### 1-1. Outline of First Embodiment

An image display device according to the present embodiment includes a first reflection type volume hologram and a second reflection type volume hologram forming a transmission type diffraction element as a whole. The first reflection type volume hologram and the second reflection type volume hologram satisfy the Bragg condition for incident light of three colors of red, green, and blue. The first reflection type volume hologram diffracts incident light incident at an incident angle θi at a connection angle θc and deflects the incident light to the second reflection type volume hologram. The second reflection type volume hologram condenses the deflected incident light. The incident angle θi and the connection angle θc satisfy the following condition 1 or condition 2.

$$10 degrees \leq incident angle θ i \leq 90 degrees , \\ 10 degrees \leq connection angle θ c \leq 90 degrees , and \\ 4 \times incident angle θ i + connection angle θ c \leq 170 degrees , \qquad ( condition 1 )$$

$$70 degrees \leq incident angle θ i \leq 90 degrees , \\ and 70 degrees \leq connection angle θ c \leq 90 degrees \qquad ( condition 2 )$$

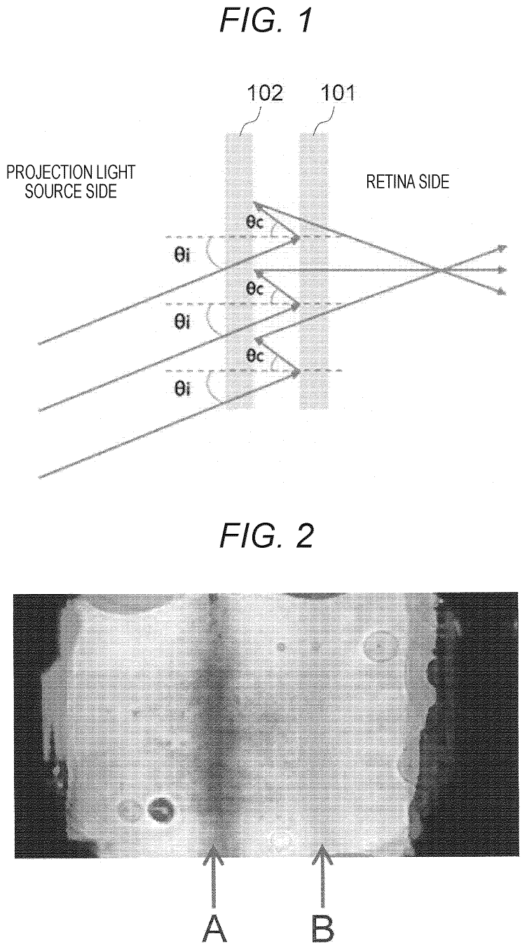

The first reflection type volume hologram is, for example, a deflective HOE and may be a deflection 101 illustrated in FIG. 1. The second reflection type volume hologram is, for example, a condensing HOE, and may be a condensing HOE 102 illustrated in FIG. 1.

In the image display device according to the present embodiment, the incident angle θi and the connection angle θc are set to satisfy the above condition 1 or condition 2. This is because dark lines and discoloration are not generated in the central portion of the field of view in the image projected on the retina.

In the image display device satisfying the above condition 1 or condition 2, the first and second reflection type volume holograms may be, for example, ideal HOEs. In a case where the second reflection type volume hologram deviates from the ideal HOE, the incident angle θi and the connection angle θc may be a combination that preferably satisfies the following condition 1a or condition 2. Note that the ideal HOE will be separately described later.

$$10 degrees \leq incidient angle θ i \leq 90 degrees , \\ 30 degrees \leq connection angle θ c \leq 90 degrees , and \\ 6 \times incident angle θ i + connection angle θ c \leq 210 degrees , \qquad ( condition 1 a )$$

$$70 degrees \leq incident angle θ i \leq 90 degrees , \\ and 70 degrees \leq connection angle θ c \leq 90 degrees \qquad ( condition 2 )$$

In a preferred embodiment, the light flux incident surface of the first reflection type volume hologram and the light flux incident surface of the second reflection type volume hologram face each other substantially in parallel. Therefore, the connection angle coincides with the incident angle of the second reflection type volume hologram. “Substantially parallel” includes not only being completely parallel but also being substantially parallel, and means including a difference of about several degrees. The difference is, for example, within ±2 degrees, preferably within ±1 degree, and more preferably within ±0.5 degrees.

In a preferred embodiment, the diffraction angle of the central portion of the second reflection type volume hologram is approximately 0 degrees. Therefore, the diffracted light from the central portion of the second reflection type volume hologram may be the center of the field of view. “Approximately 0 degrees” includes not only completely 0 degrees but also substantially 0 degrees, and means including a difference of about several degrees. The difference is, for example, within ±2 degrees, preferably within ±1 degree, and more preferably within ±0.5 degrees.

In a preferred embodiment, the incident light incident on the first reflection type volume hologram is p-polarized light. Therefore, this can reduce the degree of dark lines and discoloration in the image projected on the retina.

In a preferred embodiment, the incident light is emitted from an image formation device separated from the image display device.

The image display device according to the present embodiment may include a diffraction element other than the diffraction element described above. The image display device may further include, for example, a diffraction element having a function of preventing stray light transmitted through the reflection type volume hologram.

Hereinafter, a phenomenon in which dark lines and discoloration occur in an image projected on the retina will be specifically described. Thereafter, a preferable aspect of the present embodiment will be described with reference to a specific example regarding a condition for preventing the phenomenon from occurring in the central portion of the field of view.

### 1-2. Phenomenon of Occurrence of Dark Line and Discoloration

As described above, the present inventor has found that there is a case in which the configuration of the reflection type volume hologram as illustrated in FIG. 1 may have a phenomenon of a dark line or discoloration partially occurring in an image projected on the retina. The phenomenon will be described below.

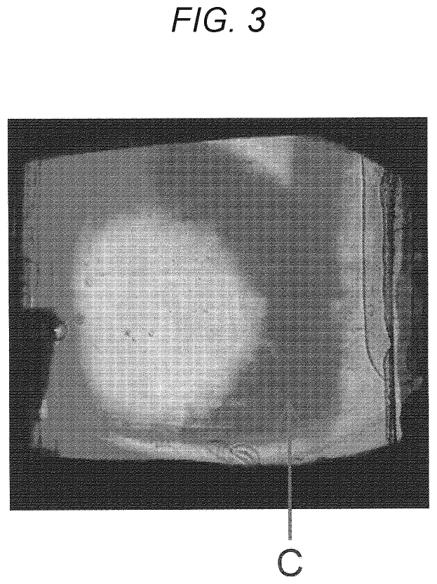

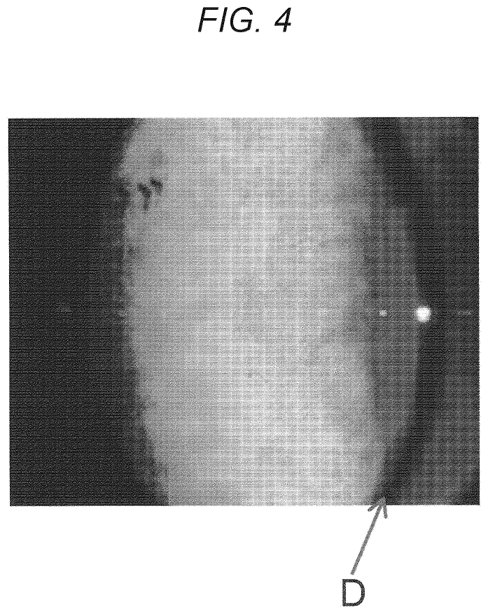

FIGS. 2 and 3 are diagrams illustrating examples of partial discoloration. FIG. 4 is a diagram illustrating an example of a partial dark line. In FIG. 2, vertical streak-like discoloration indicated by arrows A and B can be confirmed. In FIG. 3, annular discoloration indicated by an arrow C can be confirmed. In FIG. 4, a dark line indicated by an arrow D can be confirmed.

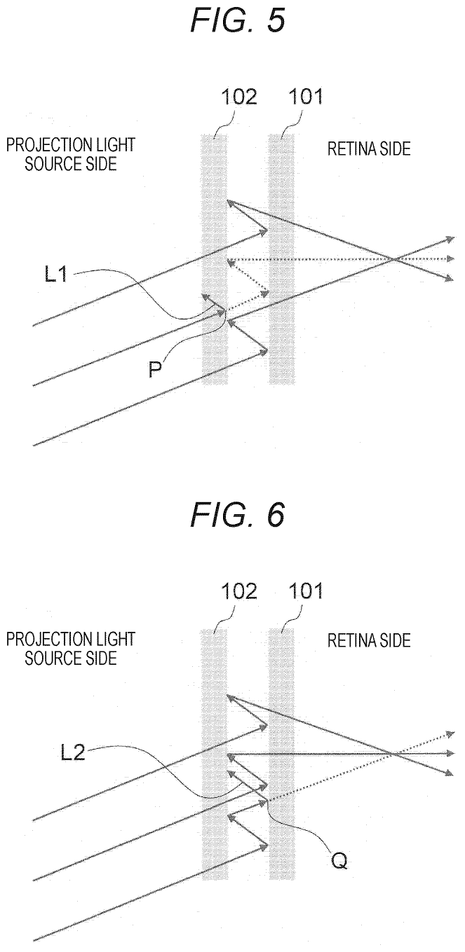

As a result of intensive studies on the above phenomenon, the present inventor has found that unnecessary diffraction occurs in the deflective HOE 101 and the condensing HOE 102 illustrated in FIG. 1. The unnecessary diffraction is roughly divided into the following two types.
1) A part of the incident light is diffracted at the condensing HOE 102 (FIG. 5).
2) A part of the diffracted light from the condensing HOE 102 is diffracted at the deflective HOE 102 (FIG. 6).

FIG. 5 is a diagram for explaining the above 1). In FIG. 5, L1 represents unnecessary diffracted light. In the drawing, in a case where the diffracted light at a point P of the condensing HOE 102 coincides with the direction of the incident light, the incident light at the point P is diffracted in the direction of the connection angle at the condensing HOE 102, and thus the incident light cannot pass through the condensing HOE 102 or the transmittance decreases. Therefore, a phenomenon occurs in which a part of the incident light (video display light) does not reach the retina.

FIG. 6 is a diagram for explaining the above 2). In FIG. 6, L2 represents unnecessary diffracted light. In the drawing, in a case where the diffracted light at a point Q of the deflective HOE 101 coincides with the direction of the incident light, the diffracted light at the point Q is diffracted in the direction of the connection angle at the deflective HOE 101, and thus cannot be transmitted through the deflective HOE 101 or the transmittance decreases. Therefore, a phenomenon occurs in which a part of the incident light (video display light) does not reach the retina.

The above phenomenon occurs in a case where the incident light is monochromatic, and can occur in each wavelength band of R/G/B. In addition, since the point P and the point Q are close to the direction of the incident light, the two phenomena of the above 1) and 2) occur simultaneously in three colors. As a result, since none of the three colors of the video in that direction reaches the retina, the video appears as a dark line as illustrated in FIG. 4.

On the other hand, as a more complicated phenomenon, it is necessary to consider unnecessary diffraction due to interaction between a hologram and incident light between R/G/B. In a case where the retinal projection device is compatible with full color, R/G/B will form diffraction gratings respectively corresponding thereto, but the diffraction grating of the R layer diffracts G light, and unnecessary diffraction between colors occurs such that G light does not reach the retina.

This phenomenon does not necessarily occur near the direction of the incident light. In addition, it is rare that three colors are simultaneously generated at the same place, and light of one color is not transmitted, so that the image appears as a streak-like or annular discoloration as illustrated in FIGS. 2 and 3.

The above-described dark lines and discolored lines depend on the state of the diffraction grating formed in the deflective HOE 101 and the condensing HOE 102. The inventor has found that the combination of the incident angle θi and the connection angle θc in the deflective HOE 101 and the condensing HOE 102 affects the appearance of dark lines and discolored lines. The present inventor has focused on selecting the incident angle θi and the connection angle θc such that the dark line and the discolored line do not enter the field of view, or such that the dark line and the discolored line do not appear in the central portion of the field of view even if it cannot be avoided to enter the field of view, and has completed the present technology. In addition, the present inventor has also found that the degree of such unnecessary diffraction also depends on the polarization state of the incident light. It is also effective to select the polarization state of the incident light for suppressing unnecessary diffraction.

1-3. Condition for Preventing Above Phenomenon from Occurring in Central Portion of Field of View

Conditions for not generating dark lines and discolored lines in the central portion of the field of view will be described with specific examples (first to third examples). In these examples, it is assumed that the image display device is a component of the retinal projection device. In these examples, the retinal projection device includes a deflective HOE 101 and a condensing HOE 102, as illustrated in FIG. 1, forming a transmission type diffraction element as a whole. In addition, the light source of the retinal projection device is assumed to be a semiconductor laser having (reproduction) wavelengths of 644 nm, 520 nm, and 446 nm. The selection of the wavelength is conceivable in addition to the above, but does not significantly affect the results of the calculation described below.

In addition, the condensing HOE 102 has different diffraction conditions in each point in a two-dimensional spread. Although it is originally necessary to perform calculation in all two-dimensional regions, it is sufficient to perform calculation in a cross section on the incident surface when estimating at which viewing angle a dark line appears. Therefore, calculation in a one-dimensional region in this cross section is hereinafter performed.

### 1-3-1. First Example

As a first example, a case where the deflective HOE and the condensing HOE are ideal HOEs will be described.

In a case where the incident angle and the connection angle are determined, the ideal deflective HOE is the HOE in which the diffraction wavelength coincides with the reproduction wavelength and the diffraction angle coincides with the connection angle with respect to the diffraction condition of the incident light incident on the deflective HOE at the incident angle.

The ideal condensing HOE is an HOE in which the diffraction wavelength matches the reproduction wavelength at any point on the condensing HOE with respect to the incident light incident at the connection angle, and the light diffracted at each point is condensed at one point.

(1) Calculation of Condition Under which Part of Incident Light is Diffracted by Condensing HOE

Hereinafter, a procedure for calculating a condition under which a part of the incident light is diffracted by the condensing HOE will be described.

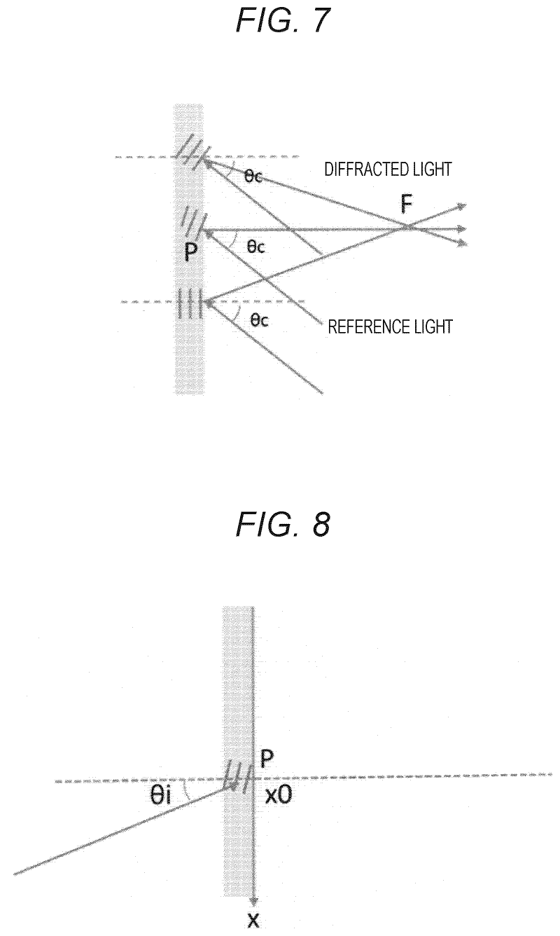

1) A diffraction grating for diffracting incident light (wavelength: reproduction wavelength) incident at the connection angle θc at the point P (x=x0) of the condensing HOE in the condensing direction (point F) is calculated (considered as interference between two plane waves) (FIG. 7).

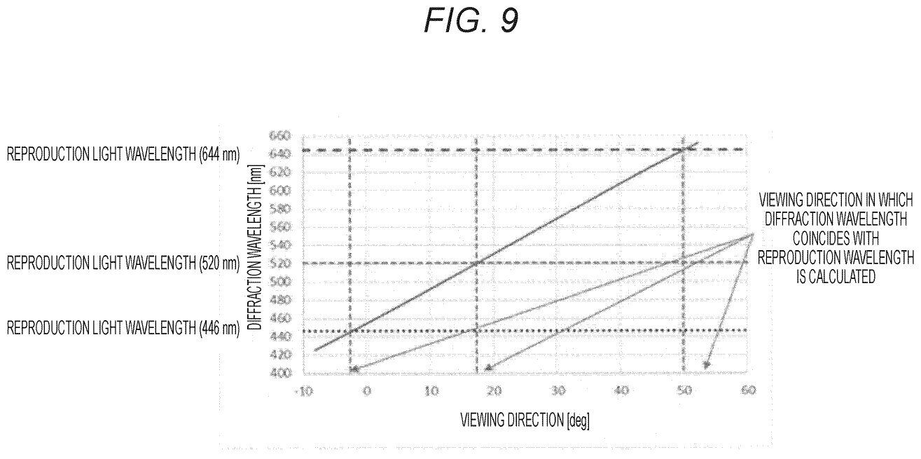

2) The diffraction wavelength satisfying the diffraction condition with the incident light incident on the diffraction grating at the calculated point P at the incident angle θi is calculated (FIG. 8).
3) A point P (x=x0) when the diffraction wavelength coincides with the reproduction wavelength is obtained, and converted into the viewing direction (angle) from the relationship with the condensing position (point F).

As an example of the calculation, FIG. 9 illustrates calculation results of the viewing direction and the diffraction wavelength in the red diffraction grating at the incident angle θi=50 degrees and the connection angle θc=60 degrees. In FIG. 9, “reproduction light wavelength (644 nm)” indicates a red reproduction wavelength, “reproduction light wavelength (520 nm)” indicates a green reproduction wavelength, and “reproduction light wavelength (446 nm)” indicates a blue reproduction wavelength.

Referring to FIG. 9, it can be seen that in a case where the viewing direction is the incident light (50 degrees), the diffraction wavelength coincides with the red reproduction wavelength. In this viewing direction, the similar result occurs in green and blue, and thus, the image is a dark line in which all R/G/B are missing. In addition, there is a viewing direction in which the diffraction wavelength coincides with the reproduction wavelengths of green and blue in spite of the red diffraction grating. In this viewing direction, an image in which green and blue are missing is obtained, and discolored lines are caused.

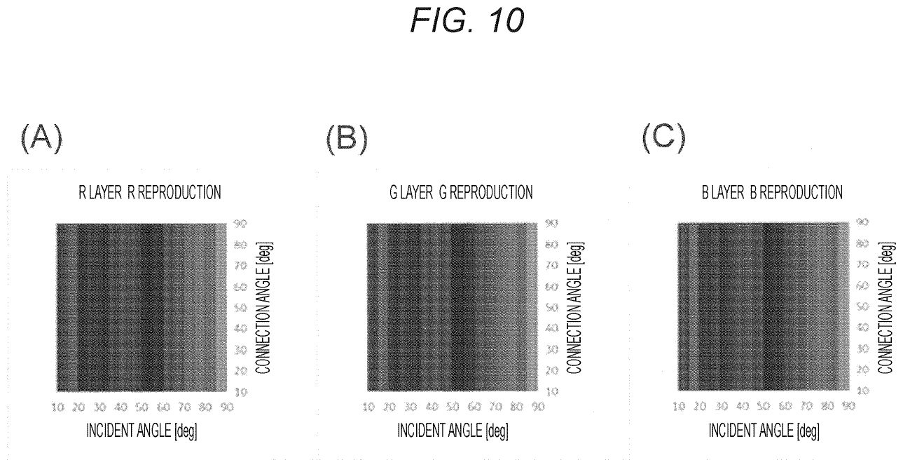

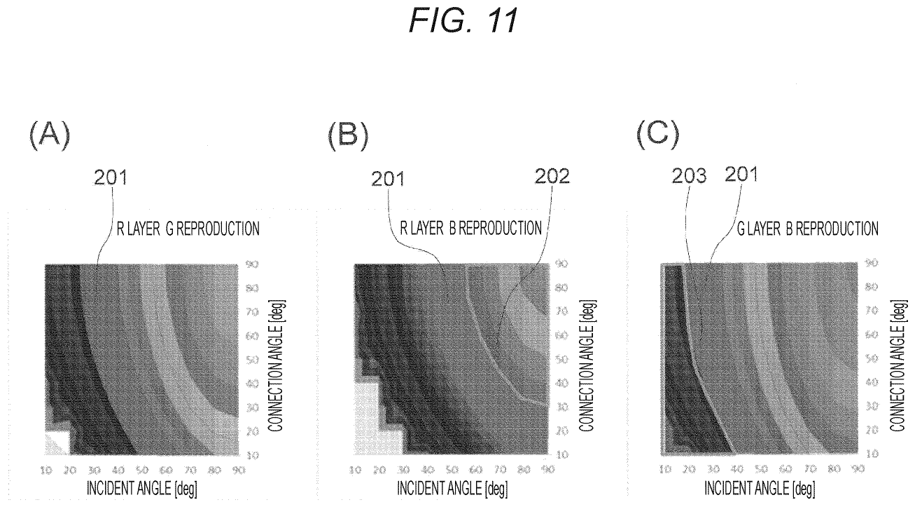

FIGS. 10 and 11 illustrate the results of calculating the viewing directions in which the reproduction lights of R/G/B are diffracted in the diffraction gratings of R/G/B with respect to the incident angles θi and the connection angles θc in this manner.

FIG. 10 illustrates a viewing direction in which a diffraction grating of each color diffracts reproduction light of the same color, in which (A) corresponds to red, (B) corresponds to green, and (C) corresponds to blue. In any case, diffraction occurs in a case where the viewing direction coincides with the incident direction. FIG. 11 illustrates a viewing direction in which a diffraction grating of each color diffracts reproduction light of another color, in which (A) corresponds to a condition in which a red diffraction grating diffracts reproduction light of green, (B) corresponds to a condition in which a red diffraction grating diffracts reproduction light of blue, and (C) corresponds to a condition in which a green diffraction grating diffracts reproduction light of blue.

Analysis has been performed assuming that the field range of view in which dark lines and discolored lines are not present is ±10 degrees. In a case where the application of the retinal projection device in this example is, for example, an assist screen of a smartphone, assuming that the projection distance is 400 mm, the field range of view of ±10 degrees corresponds to 150 mm, and assuming that the aspect ratio is 4:3, the image range is 116 mm×87 mm. Such a size is sufficient as a function as an assist screen of a smartphone.

Since visual acuity is high in the central portion of the field of view, if dark lines or discolored lines exist in the region, the commercial value is greatly impaired. On the other hand, in the field range of view of ±10 degrees or more, since the visual acuity rapidly decreases, even if there is a dark line or a discolored line in the region, the commercial value is not impaired as compared with the case where the dark line or the discolored line exists in the central portion of the field of view.

Under the above conditions, it is sufficient to set the incident angle to 10 degrees or more for the phenomenon that the diffraction gratings of the respective colors diffract the reproduction light of the same color as can be seen from FIG. 10. On the other hand, FIG. 11 illustrates the field region of view within +10 degrees as the viewing region 201 for the phenomenon in which the diffraction gratings of the respective colors diffract the reproduction light of another color. Combinations of the incident angle and the connection angle avoiding all the viewing regions 201 illustrated in (A) to (C) of FIG. 11 are indicated by a frame line 202 in (B) and indicated by a frame line 203 in (C). With the combination of the incident angle and the connection angle surrounded by the frame lines 202 and 203, dark lines and discolored lines within ±10 degrees in the viewing direction can be avoided in all the cases of (A) to (C) of FIGS. 11.

(2) Calculation of Condition Under which a Part of Diffracted Light from the Condensing HOE is Diffracted by the Deflective HOE

Hereinafter, a procedure for calculating a condition under which a part of diffracted light from the condensing HOE is diffracted by the deflective HOE will be described.

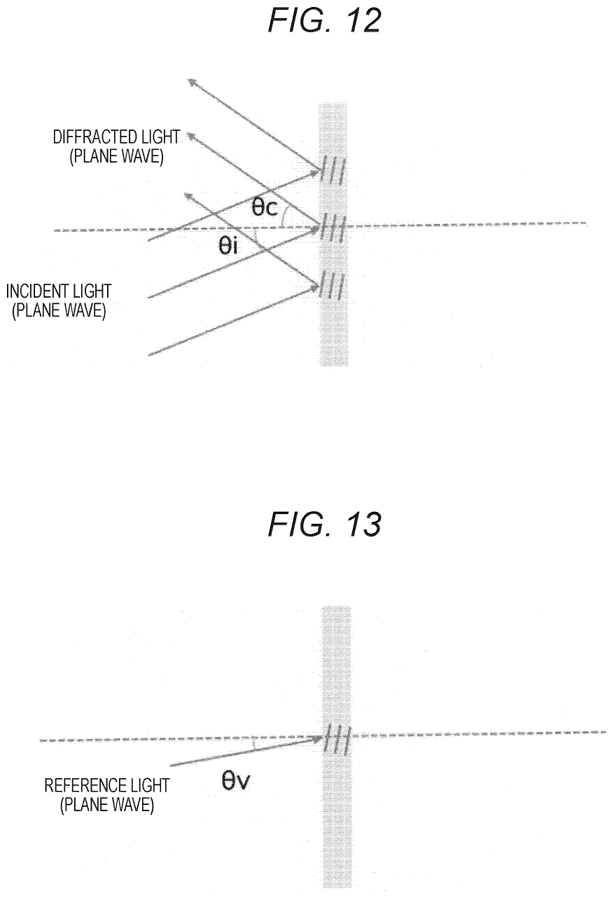

1) In the condensing HOE, a diffraction grating for diffracting incident light (wavelength: reproduction wavelength) at the incident angle θi at the connection angle θc is calculated (interference of two plane waves, identical at any location in the plane) (FIG. 12).

2) The diffraction wavelength at which the light incident on the calculated diffraction grating at the incident angle θv satisfies the diffraction condition is calculated (FIG. 13).

3) An incident angle θv (viewing direction) when the diffraction wavelength coincides with the reproduction wavelength is obtained.

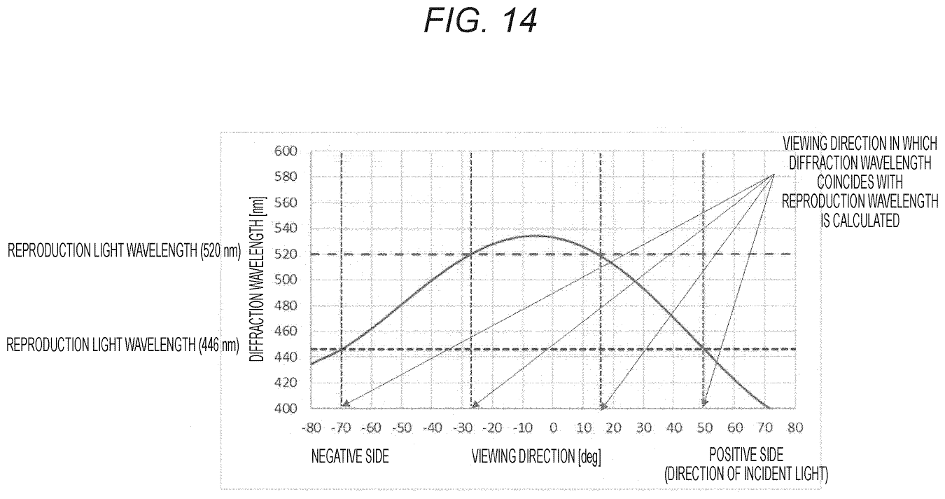

As an example of the calculation, FIG. 14 illustrates calculation results of the viewing direction and the diffraction wavelength in the blue diffraction grating at the incident angle θi=50 degrees and the connection angle θc=70 degrees. In FIG. 14, the “reproduction light wavelength (520 nm)” indicates a green reproduction wavelength, and the “reproduction light wavelength (446 nm)” indicates a blue reproduction wavelength.

As can be seen from FIG. 14, the diffraction wavelength coincides with the reproduction wavelength of blue when the incident angle θv is θi (50 degrees) and −θc (−70 degrees). This is apparent from the fact that the blue diffraction grating is formed by interference between plane waves of the incident angle θi and θc. In addition, there is a viewing direction in which the diffraction wavelength coincides with the reproduction wavelengths of green in spite of the blue diffraction grating. In this viewing direction, an image in which green is missing is obtained, and discolored lines are caused.

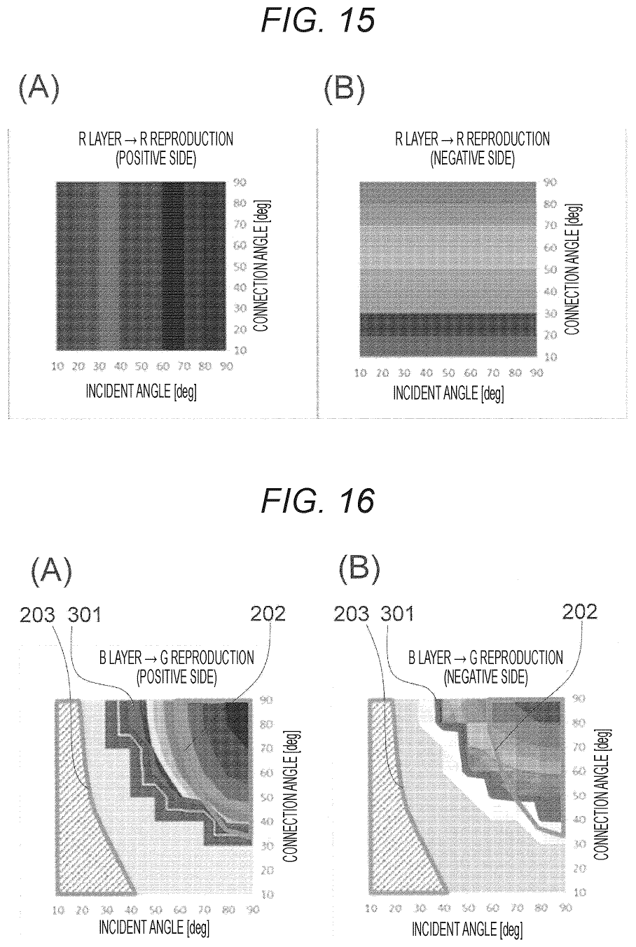

FIGS. 15 to 17 illustrate the results of calculating the viewing directions in which the reproduction lights of R/G/B are diffracted in the diffraction gratings of R/G/B with respect to the incident angles θi and the connection angles θc in this manner.

In FIG. 15, (A) corresponds to a positive side (incident light side), and (B) corresponds to a negative side (side opposite to the incident light) in the viewing direction in which the diffraction gratings of the respective colors diffract the reproduction light of the same color. In (A), in any case of R/G/B, diffraction occurs in a case where the viewing direction coincides with the incident direction. In (B), in any case of R/G/B, diffraction occurs in a case where the viewing direction coincides with the connection angle direction. Note that, in (A) and (B), only a case where red reproduction light is diffracted by a red diffraction grating is described, but the same graph is applied to the cases of green and blue.

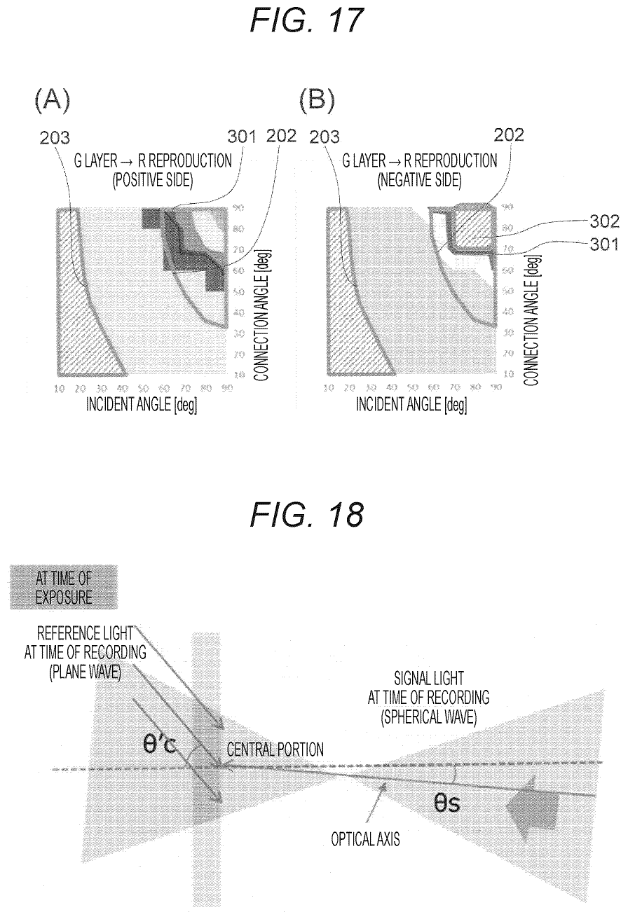

FIGS. 16 and 17 illustrate viewing directions in which diffraction gratings of different colors diffract reproduction light, FIG. 16 illustrates a condition in which a blue diffraction grating diffracts green reproduction light, and FIG. 17 illustrates a condition in which a green diffraction grating diffracts red reproduction light. In both FIGS. 16 and 17, (A) corresponds to a positive side (incident light side), and (B) corresponds to a negative side (side opposite to the incident light). A region surrounded by the frame lines 202 and 203 indicates a region where a dark line and a discolored line within ±10 degrees in the viewing direction can be avoided when the condition that a part of the incident light is diffracted by the condensing HOE is calculated in the above (1). In addition, in FIGS. 16 and 17, a viewing region within +10 degrees is illustrated as a viewing region 301.

In the region where the incident angle θi is small, the allowable range (region surrounded by the frame line 203) of the above (1) is included in the allowable range of the above (2). On the other hand, in the region where the incident angle θi is large, the allowable range in the above (2) is wide in the case of FIG. 16 (blue diffraction grating→green reproduction light diffraction), but the ranges of the incident angle θi and the connection angle θc allowed under this condition are narrow in the case of FIG. 17 (green diffraction grating→red reproduction light diffraction). However, the region 302 illustrated in FIG. 17 can avoid the viewing region 301 illustrated in FIGS. 16 and 17. As a result, in the region 302, dark lines and discolored lines within ±10 degrees in the viewing direction can be avoided in both of the above (1) (case where a part of the incident light is diffracted by the condensing HOE) and the above (2) (case where a part of the diffracted light from the condensing HOE is diffracted by the deflective HOE).

### (3) Allowable Range of Incident Angle θi and Connection Angle θc in First Example

In the first example, a combination of the incident angle θi and the connection angle θc at which a dark line and a discolored line due to both the above factors (1) and (2) do not occur within ±10 degrees of the field of view satisfies the following condition 1 or 2.

$$10 degrees \leq incident angle θ i \leq 90 degrees , \\ 10 degrees \leq connection angle θ c \leq 90 degrees , and \\ 4 \times incident angle θ i + connection angle θ c \leq 170 degrees , \qquad ( condition 1 )$$

$$70 degrees \leq incident angle θ i \leq 90 degrees , \\ and 70 degrees \leq connection angle θ c \leq 90 degrees \qquad ( condition 2 )$$

The above condition 1 corresponds to a region (a region having a small incident angle θi) surrounded by the frame line 203 illustrated in FIG. 17. The above condition 2 corresponds to the region 301 (a region having a large incident angle θi) illustrated in FIG. 17.

### 1-3-2. Second Example

As a second example, a case where the condensing HOE deviates from the ideal HOE will be described.

In the first example, a case where the condensing HOE is the ideal HOE, that is, a case of the HOE in which the diffraction wavelength coincides with the reproduction wavelength at any point on the condensing HOE with respect to the light incident at the connection angle and the light diffracted at each point is condensed at one point has been described. However, in practice, there is a case where the condensing HOE may deviate from the ideal HOE for the following two reasons.

### <Reason 1: Wavelength of Reproduction Light and Exposure Wavelength are Different>

There are many cases where a semiconductor laser is used for the reproduction light in terms of ease of handling and cost. On the other hand, regarding exposure of a hologram, it is difficult to use a semiconductor laser from the viewpoint of coherence performance and light intensity. Therefore, since the light source is different between the time of reproduction and the time of exposure, there are many cases where the wavelength is different between the time of reproduction and the time of exposure.

### <Reason 2. Deformation of Material Before and After Exposure>

There are many cases where photopolymers are used for hologram materials. In a photopolymer, since a diffraction grating is formed by a photopolymerization reaction, there are many cases where deformation (shrinkage) of a material is involved in exposure. Therefore, even if exposure can be performed at the same wavelength as at the time of reproduction, since the material is deformed after exposure, information of the interference fringes at the time of exposure cannot be accurately reflected on the diffraction grating in the hologram material.

Since the deflective HOE is interference due to two plane waves, even in a case where the wavelength at the time of exposure is different from the wavelength at the time of reproduction and material deformation occurs, it is possible to create an ideal HOE in which the reproduction light incident at the incident angle θi is diffracted at the diffraction angle θc by adjusting the angle at the time of exposure (slightly deviating from θi and θc).

On the other hand, regarding the condensing HOE, it is difficult to form an interference fringe satisfying the diffraction condition at the time of reproduction at all points in the plane by adjusting the angle at the time of exposure. However, if the exposure wavelength can be changed (in a case where the material shrinks, select a wavelength that is longer by the shrinkage of the material) with respect to the reproduction wavelength by the material deformation, it is possible to create a substantially ideal HOE.

(1) Calculation of Condition Under which Part of Incident Light is Diffracted by Condensing HOE

The parameters of the optical system and the material in the second example are shown in the following Tables 1 and 2. In Table 1, the reproduction wavelength and the exposure wavelength are described. In Table 2, physical property values of the hologram material are described.

TABLE 1

| | Red | Green | Blue |
|---|---|---|---|
| Reproduction | 644 nm | 520 nm | 446 nm |
| wavelength | | | |
| Exposure wavelength | 660 nm | 532 nm | 460 nm |

TABLE 2

| Refractive index | | | Shrinkage | | |
|---|---|---|---|---|---|
| R | G | B | R | G | B |
| 1.518 | 1.539 | 1.551 | 1.17% | 0.85% | 0.85% |

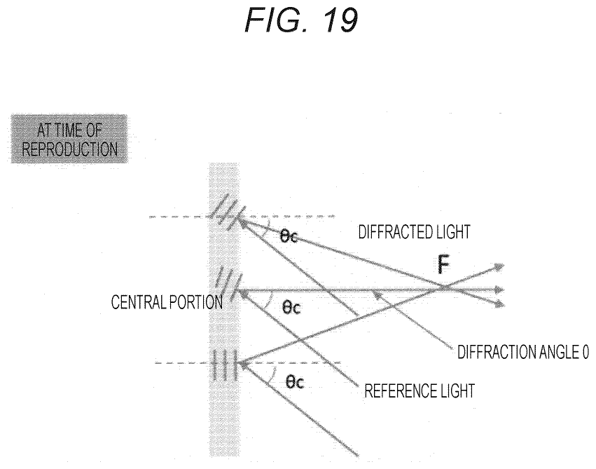

FIG. 18 is a schematic diagram illustrating an optical system during the exposure of the condensing HOE. FIG. 19 is a schematic diagram illustrating an optical system during the reproduction of the condensing HOE. Regarding the condensing HOE, as illustrated in FIG. 19, the angles of the reference light (plane wave) and the signal light (spherical wave) at the time of exposure are adjusted such that the reproduction light incident at the connection angle θc at the time of reproduction is diffracted at a diffraction angle of 0 degrees (direction perpendicular to the plane) in the central portion of the HOE (point on the optical axis of the lens light at the time of exposure).

When the exposure angle is determined in this manner, the diffraction grating at an arbitrary point on the condensing HOE after the exposure can be calculated. For the diffraction grating calculated in this manner, the viewing direction (angle) when the diffraction wavelength coincides with the reproduction wavelength can be calculated by the procedure of 2) and the subsequent procedures described in “(1) Calculation of condition under which part of incident light is diffracted by condensing HOE” of the first example.

When the diffraction grating is formed on the hologram material as in the second example, the exposure wavelength is usually selected to be longer than the reproduction wavelength in consideration of material shrinkage after exposure. However, if the connection angle is too small, the interval between the diffraction gratings forming the condensing HOE becomes too narrow, and as described above, it becomes difficult to adjust the angle between the reference light (plane wave) and the signal light (spherical wave) at the time of exposure so that the diffraction angle is diffracted to 0 degrees (direction perpendicular to the plane) at the central portion of the HOE (point on the optical axis of the lens light at the time of exposure). In particular, if the connection angle is 30 degrees or less, the diffraction condition of the central portion cannot be satisfied with the optical parameters in the second example. In order to avoid such a situation, the connection angle is preferably set to 30 degrees or more.

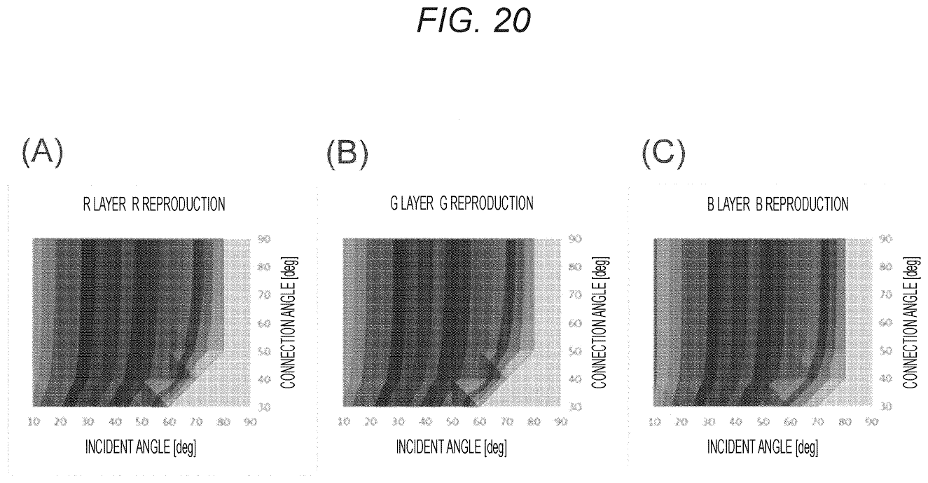

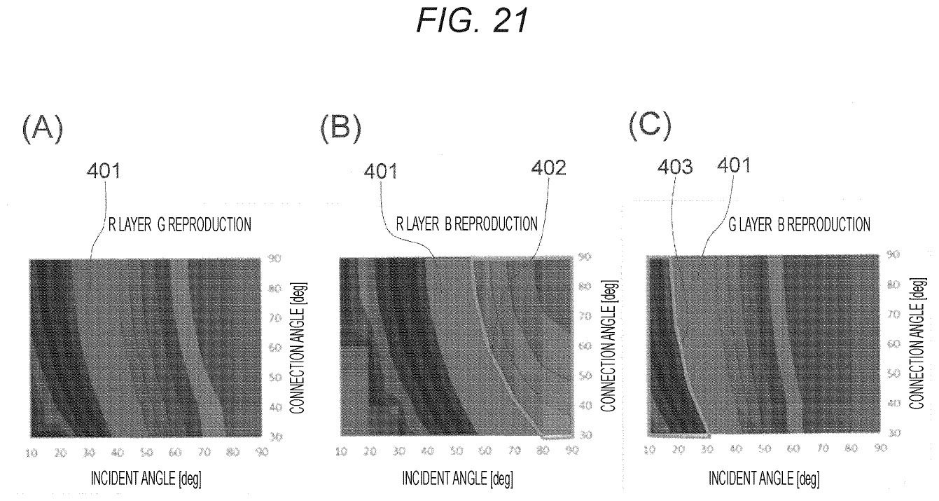

FIGS. 20 and 21 illustrate the results of calculating the viewing directions in which the reproduction lights of R/G/B are diffracted in the diffraction gratings of R/G/B with respect to the incident angles θi and the connection angles θc also under such conditions.

FIG. 20 illustrates a viewing direction in which a diffraction grating of each color diffracts reproduction light of the same color, in which (A) corresponds to Red, (B) corresponds to Green, and (C) corresponds to Blue. Due to the shrinkage of the material, as in the first example, diffraction occurs under the condition that the viewing direction is close to the incident direction although the viewing direction does not completely coincide with the incident direction in any case. Therefore, in order not to generate the dark line and the discolored line within ±10 degrees of the field of view as in the first example, it is sufficient to set the incident angle to 10 degrees or more for the phenomenon that the diffraction gratings of the respective colors diffract the reproduction light of the same color.

FIG. 21 illustrates a viewing direction in which a diffraction grating of each color diffracts reproduction light of another color, in which (A) corresponds to a condition in which a red diffraction grating diffracts reproduction light of green, (B) corresponds to a condition in which a red diffraction grating diffracts reproduction light of blue, and (C) corresponds to a condition in which a green diffraction grating diffracts reproduction light of blue. In FIG. 21, a viewing region within ±10 degrees is illustrated as a viewing region 401. Combinations of the incident angle and the connection angle avoiding all the viewing regions 401 illustrated in (A) to (C) of FIG. 21 are indicated by a frame line 402 in (B) and indicated by a frame line 403 in (C). With the combination of the incident angle and the connection angle surrounded by the frame lines 402 and 403, dark lines and discolored lines within +10 degrees in the viewing direction can be avoided in all the cases of (A) to (C) of FIG. 21.

(2) Calculation of Condition Under which a Part of Diffracted Light from the Condensing HOE is Diffracted by the Deflective HOE

As described above, regarding the deflective HOE, the angle at the time of exposure is adjusted so that the reproduction wavelength becomes the diffraction wavelength at each of the incident angle and the connection angle. If such an exposure angle is adjusted, the exposure wavelength is different from the reproduction wavelength, and even if the material is shrunk, the ideal HOE can be created, so that the condition under which a part of the diffracted light from the condensing HOE is diffracted by the deflective HOE is the same as in the first example.

In a case where the diffraction gratings of the respective colors diffract the reproduction light of the same color as illustrated in FIG. 15, (A) (positive side, incident light side) shows diffraction in a case where the viewing direction coincides with the incident direction in any R/G/B, and (B) (negative side, opposite side of incident light) shows diffraction in a case where the viewing direction coincides with the connection angle direction in any R/G/B. Therefore, if the incident angle is set to 10 degrees or more and the connection angle is set to 30 degrees or more, dark lines and discolored lines within ±10 degrees in the viewing direction can be avoided.

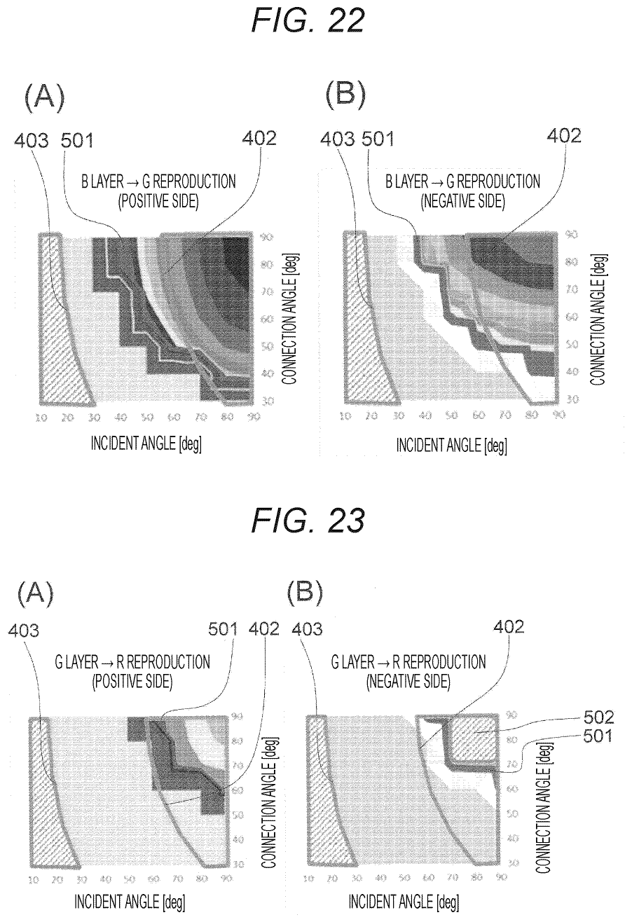

Next, a condition that the diffraction grating of each color diffracts the reproduction light of another color will be considered. In the viewing direction, FIG. 22 illustrates a condition that the blue diffraction grating diffracts the green reproduction light similarly to FIG. 16, and FIG. 23 illustrates a condition that the green diffraction grating diffracts the red reproduction light similarly to FIG. 17. In both FIGS. 22 and 23, (A) corresponds to a positive side (incident light side), and (B) corresponds to a negative side (side opposite to the incident light). A region surrounded by the frame lines 402 and 403 indicates a region where a dark line and a discolored line within ±10 degrees in the viewing direction can be avoided when the condition that a part of the incident light is diffracted by the condensing HOE is calculated in the above (1). In addition, in FIGS. 22 and 23, a viewing region within ±10 degrees is illustrated as a viewing region 501.

In the region where the incident angle θi is small, the allowable range (region surrounded by the frame line 403) of the above (1) is included in the allowable range of the above (2). On the other hand, in the region where the incident angle θi is large, the allowable range in the above (2) is wide in the case of FIG. 22 (blue diffraction grating→green reproduction light diffraction), but the ranges of the incident angle θi and the connection angle θc allowed under this condition are narrow in the case of FIG. 23 (green diffraction grating→red reproduction light diffraction). However, the region 502 illustrated in FIG. 23 can avoid the viewing region 501 illustrated in FIGS. 22 and 23. As a result, in the region 502, dark lines and discolored lines within ±10 degrees in the viewing direction can be avoided in both of the above (1) (case where a part of the incident light is diffracted by the condensing HOE) and the above (2) (case where a part of the diffracted light from the condensing HOE is diffracted by the deflective HOE).

### (3) Allowable Range of Incident Angle θi and Connection Angle θc in Second Example

In the second example, a combination of the incident angle θi and the connection angle θc at which a dark line and a discolored line due to both the above factors (1) and (2) do not occur within ±10 degrees of the field of view satisfies the following condition 1a or 2.

$$10 degrees \leq incidient angle θ i \leq 90 degrees , \\ 30 degrees \leq connection angle θ c \leq 90 degrees , and \\ 6 \times incident angle θ i + connection angle θ c \leq 210 degrees , \qquad ( condition 1 a )$$

$$70 degrees \leq incident angle θ i \leq 90 degrees , \\ and 70 degrees \leq connection angle θ c \leq 90 degrees \qquad ( condition 2 )$$

The above condition 1a corresponds to a region (a region having a small incident angle θi) surrounded by the frame line 403 illustrated in FIG. 23. The above condition 2 corresponds to the region 501 (a region having a large incident angle θi) illustrated in FIG. 23.

### 1-3-3. Third Example

As a third example, polarization dependency in a case where a part of incident light is diffracted by the condensing HOE will be described.

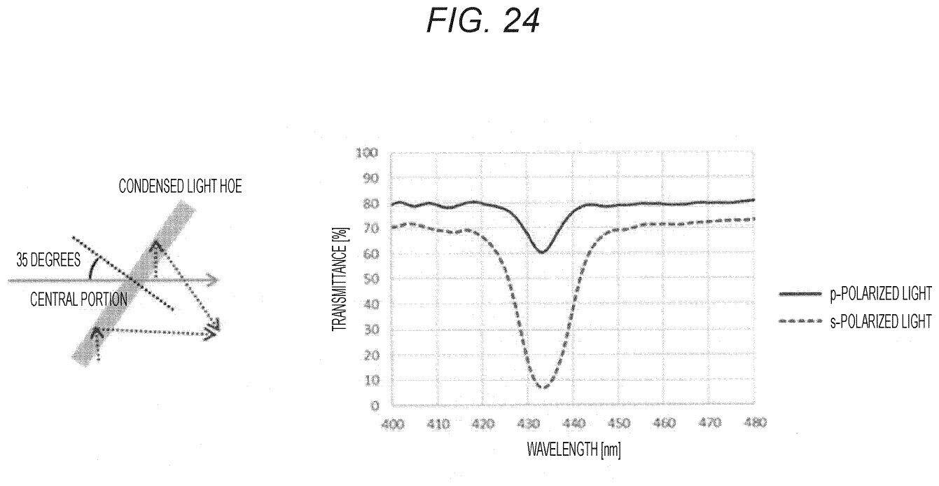

As described in the first and second examples, the present inventor has found that there is polarization dependency in the dark line and the discolored line in which a part of the incident light is diffracted by the condensing HOE. FIG. 24 illustrates spectral characteristics of transmitted light of light incident at an incident angle of 35 degrees on a central portion of the green condensing HOE exposed at a connection angle of 50 degrees. As can be seen from the graph illustrated on the right side of FIG. 24, although the diffraction condition is in the blue region, the drop of the amount of transmitted light is different between the p-polarized light and the s-polarized light, and the drop of the p-polarized light is smaller. This indicates that the degree of dark lines and discolored lines can be reduced by selecting p-polarized light.

### 2. Second Embodiment (Display Device)

The present technology also provides a display device including the image display device described in the above “1. First Embodiment (Image Display Device)” and an image formation device that emits incident light. the image display device is as described above in “1. First Embodiment (Image Display Device)”, and the description also applies to the present embodiment.

Specifically, the display device according to the present embodiment is a retinal projection type display device that displays an image by projecting a light flux (image) onto the retina of the user. In the display device according to the present embodiment, the image formation device may be separated from the image display device. For example, the image formation device may be disposed far away from the image display device.

FIG. 25 is a schematic diagram illustrating an example of a display device 1 according to the present embodiment. As illustrated in FIG. 25, the display device 1 includes an image display device 20 and an image formation device 10. The image display device 20 includes a first reflection type volume hologram and a second reflection type volume hologram forming a transmission type diffraction element 21 as a whole. The diffraction element 21 is disposed in front of eyes (both eyes or one eye) 3 of a user 2 by an instrument 22. The instrument 22 is, for example, glasses worn on the head of user 2. The image formation device 10 emits incident light toward the diffraction element 21. In other words, the incident light is video display light. That is, the image formation device 10 projects video display light toward the diffraction element 21. The diffraction element 21 diffracts the video display light to cause the video display light to reach the retina of the user 2. Therefore, the user 2 of the display device 1 can see a video 4 (still image or moving image) formed by the video display light. Further, the diffraction element 21 transmits light from a space in front of the instrument 22 (in the line-of-sight direction of the user 2) to reach the eyes of the user 2. Therefore, the user 2 recognizes the video 4 as a video existing in the space.

The image formation device 10 includes at least one projection optical system. The video display light projected from the projection optical system may be light irradiated by an LED or a CRT. The video display light can be, for example, laser light.

The projection optical system is configured so that the video display light can be projected toward the diffraction element 21. A type of a projection optical system adopted in the present technology may be selected as appropriate by those skilled in the art according to, for example, a product concept, or the like.

According to one embodiment of the present technology, the projection optical system may be configured to project video display light to both eyes by a magnifying optical system. The magnifying optical system is an optical system adopted in, for example, a microscope, a telescope, and the like. According to another embodiment of the present technology, the projection optical system may be configured such that video display light is condensed near a pupil and then emitted to a retina.

The image formation device 10 may be, for example, a portable device such as a smartphone, a mobile phone, or a watch-type terminal. By adopting such a portable device as the image formation device 10 in the display device 1 of the present technology, video projection according to the present technology can be performed by a small or ultra-small mobile device.

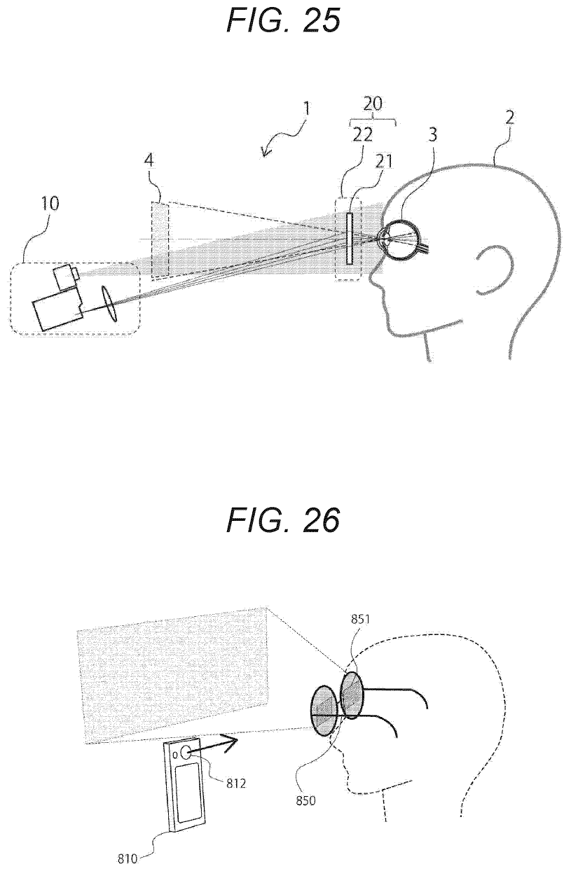

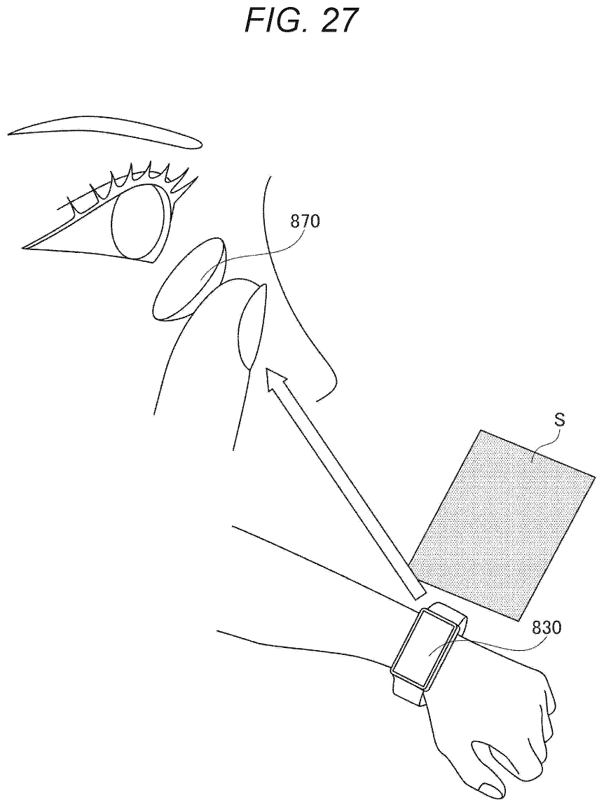

FIG. 26 illustrates an example of a state in which a user uses a display device according to the present technology including an image formation device that is a smartphone. Eyeglasses 850 are worn on the head of the user, and a diffraction element 851 according to the present technology is provided in the eyeglasses 850. In addition, the user carries a smartphone 810 in the hand, for example. Video display light is projected from a projection port 812 of the smartphone 810 toward a diffraction element 851. The video display light is diffracted by the diffraction element 851 and reaches both eyes of the user. Therefore, the user recognizes the video superimposed on the outside landscape.

In addition, the diffraction element 851 may have an optical characteristic of functioning as a lens for light in a wavelength range of the video display light and transmitting light having a wavelength outside the wavelength range. Therefore, the image by the video display light is superimposed on the outside landscape.

FIG. 27 illustrates an example of a display device according to the present technology including an image formation device that is a watch-type terminal. The user wears contact lenses 870 on both eyes. The contact lens 870 includes a diffraction element according to the present technology. In addition, the user wears a watch-type terminal 830 on the wrist, for example. Video display light is projected from the watch-type terminal 830 toward the diffraction element of the contact lens 870. The video display light is diffracted by the diffraction element of the contact lens 870. The user can view the virtual image (for example, virtual screen S illustrated in FIG. 27) through the contact lens.

The present technology may also take the following configuration.

[1]

An image display device including:
a first reflection type volume hologram and a second reflection type volume hologram forming a transmission type diffraction element as a whole, in which
the first reflection type volume hologram and the second reflection type volume hologram satisfy a Bragg condition for incident light of three colors of red, green, and blue,
the first reflection type volume hologram diffracts the incident light incident at an incident angle θi at a connection angle θc and deflects the incident light to the second reflection type volume hologram,
the second reflection type volume hologram condenses the deflected incident light, and
the incident angle θi and the connection angle θc satisfy following condition 1 or condition 2:

$$10 degrees \leq incident angle θ i \leq 90 degrees , \\ 10 degrees \leq connection angle θ c \leq 90 degrees , and \\ 4 \times incident angle θ i + connection angle θ c \leq 170 degrees , \\ and \qquad ( condition 1 )$$

$$70 degrees \leq incident angle θ i \leq 90 degrees , \\ and 70 degrees \leq connection angle θ c \leq 90 degrees . \qquad ( condition 2 )$$

[2]

The image display device according to [1], in which the incident angle θi and the connection angle θc satisfy following condition 1a or condition 2:

$$10 degrees \leq incidient angle θ i \leq 90 degrees , \\ 30 degrees \leq connection angle θ c \leq 90 degrees , and \\ 6 \times incident angle θ i + connection angle θ c \leq 210 degrees , \\ and \qquad ( condition 1 a )$$

$$70 degrees \leq incident angle θ i \leq 90 degrees , \\ and 70 degrees \leq connection angle θ c \leq 90 degrees . \qquad ( condition 2 )$$

[3]

The image display device according to [1] or [2], in which a light flux incident surface of the first reflection type volume hologram and a light flux incident surface of the second reflection type volume hologram face each other substantially in parallel.

[4]

The image display device according to any one of [1] to [3], in which a diffraction angle of a central portion of the second reflection type volume hologram is approximately 0 degrees.

[5]

The image display device according to any one of [1] to [4], in which the incident light incident on the first reflection type volume hologram is p-polarized light.

[6]

The image display device according to any one of [1] to [5], in which the incident light is emitted from an image formation device separated from the image display device.

[7]

A display device including:
an image display device that includes a first reflection type volume hologram and a second reflection type volume hologram forming a transmission type diffraction element as a whole, in which
the first reflection type volume hologram and the second reflection type volume hologram satisfy a Bragg condition for incident light of three colors of red, green, and blue,
the first reflection type volume hologram diffracts the incident light incident at an incident angle θi at a connection angle θc and deflects the incident light to the second reflection type volume hologram,
the second reflection type volume hologram condenses the deflected incident light, and
the incident angle θi and the connection angle θc satisfy following condition 1 or condition 2; and
an image formation device that emits the incident light:

$$10 degrees \leq incident angle θ i \leq 90 degrees , \\ 10 degrees \leq connection angle θ c \leq 90 degrees , and \\ 4 \times incident angle θ i + connection angle θ c \leq 170 degrees , \\ and \qquad ( condition 1 )$$

$$70 degrees \leq incident angle θ i \leq 90 degrees , \\ and 70 degrees \leq connection angle θ c \leq 90 degrees . \qquad ( condition 2 )$$

### REFERENCE SIGNS LIST

1 Display device
2 User
3 Eye
4 Video
10 Image formation device
20 Image display device
21 Diffraction element
22 Instrument
101 Polarized HOE
102 Condensing HOE

What is claimed is:

1. An image display device, comprising:
a first reflection type volume hologram and a second reflection type volume hologram forming a transmission type diffraction element as a whole, wherein
the first reflection type volume hologram and the second reflection type volume hologram satisfy a Bragg condition for incident light of three colors of red, green, and blue,
the first reflection type volume hologram diffracts the incident light incident at an incident angle θi at a connection angle θc and deflects the incident light to the second reflection type volume hologram,
the second reflection type volume hologram condenses the deflected incident light, and
the incident angle θi and the connection angle θc satisfy following condition 1 or condition 2:
$$10 degrees \leq incident angle θ i \leq 90 degrees , \\ 10 degrees \leq connection angle θ c \leq 90 degrees , and \\ 4 \times incident angle θ i + connection angle θ c \leq 170 degrees , \\ and \qquad ( condition 1 )$$
$$70 degrees \leq incident angle θ i \leq 90 degrees , \\ and 70 degrees \leq connection angle θ c \leq 90 degrees . \qquad ( condition 2 )$$

2. The image display device according to claim 1, wherein the incident angle θi and the connection angle θc satisfy following condition 1a or condition 2:
$$10 degrees \leq incidient angle θ i \leq 90 degrees , \\ 30 degrees \leq connection angle θ c \leq 90 degrees , and \\ 6 \times incident angle θ i + connection angle θ c \leq 210 degrees , \\ and \qquad ( condition 1 a )$$
$$70 degrees \leq incident angle θ i \leq 90 degrees , \\ and 70 degrees \leq connection angle θ c \leq 90 degrees . \qquad ( condition 2 )$$

3. The image display device according to claim 1, wherein a light flux incident surface of the first reflection type volume hologram and a light flux incident surface of the second reflection type volume hologram face each other substantially in parallel.

4. The image display device according to claim 1, wherein a diffraction angle of a central portion of the second reflection type volume hologram is approximately 0 degrees.

5. The image display device according to claim 1, wherein the incident light incident on the first reflection type volume hologram is p-polarized light.

6. The image display device according to claim 1, wherein the incident light is emitted from an image formation device separated from the image display device.

7. A display device, comprising:
an image display device that includes a first reflection type volume hologram and a second reflection type volume hologram forming a transmission type diffraction element as a whole, wherein
the first reflection type volume hologram and the second reflection type volume hologram satisfy a Bragg condition for incident light of three colors of red, green, and blue,
the first reflection type volume hologram diffracts the incident light incident at an incident angle θi at a connection angle θc and deflects the incident light to the second reflection type volume hologram,
the second reflection type volume hologram condenses the deflected incident light, and
the incident angle θi and the connection angle θc satisfy following condition 1 or condition 2; and
an image formation device that emits the incident light:
$$10 degrees \leq incident angle θ i \leq 90 degrees , \\ 10 degrees \leq connection angle θ c \leq 90 degrees , and \\ 4 \times incident angle θ i + connection angle θ c \leq 170 degrees , \\ and \qquad ( condition 1 )$$
$$70 degrees \leq incident angle θ i \leq 90 degrees , \\ and 70 degrees \leq connection angle θ c \leq 90 degrees . \qquad ( condition 2 )$$
